(19) United States
(12) Patent Application Publication
(10) Pub. No.: US 2026/0339129 A1
(43) Pub. Date: Oct. 29, 2026

(54) Gain Equalizer

(71) Applicant: NTT, Inc., Tokyo (JP)

(72) Inventors: Yoshie Morimoto, Musashino-shi, Tokyo (JP); Kenya Suzuki, Musashino-shi, Tokyo (JP); Keita Yamaguchi, Musashino-shi, Tokyo (JP)

(21) Appl. No.: 18/995,569

(22) PCT Filed: Aug. 15, 2022
(86) PCT No.: PCT/JP2022/030895

§ 371 Date: Jan. 16, 2025

(51) Int. Cl. G02F 1/01

(52) U.S. Cl. CPC G02F 1/0147

(57) ABSTRACT

A gain equalizer that realizes a gain equalization spectrum having a high degree of freedom with less power consumption is provided. The gain equalizer includes: an optical waveguide circuit formed on a substrate and configured with an input waveguide, N (N is an integer equal to or greater than 3) 2-input and 2-output optical multiplexing/demultiplexing circuits, N-1 arm waveguides configured with two waveguides providing connections between the optical multiplexing/demultiplexing circuits, and an output waveguide, the optical waveguide circuit including a phase shifter loaded on at least one of the arm waveguides; and an optical folded part configured to output light input from the output waveguide to the output waveguide again.

### TECHNICAL FIELD

The present invention relates to a gain equalizer configured with an optical waveguide.

### BACKGROUND ART

Optical communication networks are rapidly developing against the backdrop of the explosive increase in data communication typified by the Internet. Among these, a wavelength division multiplexing (WDM) technique capable of transmitting a large number of wavelength signals through one optical fiber core is considered to be important as a means for realizing large-capacity optical communication. Wavelength multiplexing/demultiplexing elements, optical amplifiers, and the like play an important role in realizing the WDM technique. Particularly, in order to apply the WDM technique to long-distance transmission of 100 km or more, it is necessary to dispose optical amplifiers at constant intervals in a transmission fiber, and the wavelength dependency of a gain spectrum significantly influences on an optical signal-to-noise ratio (OSNR). For example, a gain equalizer disclosed in NPL 1 has been proposed for flattening a gain spectrum.

Incidentally, there are several methods of realizing various optical function circuits required in optical communication networks. For example, a method of forming an optical waveguide made of a quartz-based material on a silicon substrate, called a planar lightwave circuit (PLC), has been widely used as a method combining multi-functionality, mass productivity, and low cost.

Optical circuits using a quartz-based glass waveguide use the same material as optical fibers used in optical communication, and thus can realize a low-loss optical waveguide. In addition, since waveguides are formed on a planar substrate, it is easy to combine various functional elements, and complex optical circuits can be manufactured with good reproducibility. Wavelength multiplexing/demultiplexing elements, optical switches, and the like manufactured using these techniques are essential components in configuring optical networks.

The gain equalizer disclosed in NPL 1 is configured with Mach-Zehnder interferometers connected in multiple stages, and therefore has a drawback of large loss. This is based on the essential cause of optical signals being discarded to unconnected output ports in each stage of the Mach-Zehnder interferometer. On the other hand, NPL 2 discloses a gain equalizer with a configuration called a lattice circuit.

A gain equalizer with a lattice-type optical circuit is configured with N-1 arm waveguides configured with N directional couplers and two waveguides interposed therebetween. In addition, by applying heat to any one of the arm waveguides, the phase of light propagating through the waveguide is controlled by a phase shifter that utilizes a change in refractive index caused by the thermo-optic effect. By adjusting the phase difference between light signals propagating through the two waveguides constituting the arm waveguide of the front-stage directional coupler, the interference state in the rear-stage directional coupler is adjusted to control the transmission spectrum relative to the wavelength of the propagating light.

In a gain equalizer with a lattice-type optical circuit, the phase shifter is controlled by utilizing the thermo-optic effect in the arm waveguides of a plurality of directional couplers to control a final output wavelength spectrum. The phase difference Θᵢ occurring between the upper arm waveguide and the lower arm waveguide in the i-th arm waveguide of the (N-1)-stage lattice-type optical circuit configured with N-1 arm waveguides configured with N directional couplers and two waveguides interposed therebetween is expressed by Equation (1).

$$[ Math . 1 ]$$

$${Θ}_{i} = \frac{2 π}{λ} {n}_{eff} {L}_{i} + {ϕ}_{i} \qquad ( 1 )$$

Here, λ represents the wavelength of light, n_{eff} represents the effective refractive index of the optical waveguide, ΔLᵢ represents the difference in length between the upper arm waveguide and the lower arm waveguide in the i-th arm waveguide, and φᵢ represents the phase difference applied between the arm waveguides by controlling the phase shifter in the i-th arm waveguide. In the configuration of a gain equalizer with a lattice-type optical circuit, a desired gain equalization spectrum is obtained by appropriately controlling the phase difference φᵢ applied between the arm waveguides.

Examples of the phase shifter include a thermo-optic phase shifter that utilizes heat generated by a heater and the thermo-optic effect. In the case of a thermo-optic phase shifter, heat to be generated is controlled by the amount of current applied to a heater, and a resultant refractive index change and amount of phase modulation are controlled. As the phase difference to be applied increases, a larger amount of driving current is required.

FIG. 1 illustrates a gain equalization spectrum example in a conventional lattice-type optical circuit. The horizontal axis represents the wavelength of light, and the vertical axis represents the light intensity transmittance of the gain equalizer. The wavelength range required for the gain equalizer is assumptively represented by Δλ₁ (1525 to 1570 nm in FIG. 1). The minimum transmittance of light intensity within Δλ₁ is assumptively represented by Lossₘₐₓ (−9 dB in FIG. 1), and the maximum transmittance is assumptively represented by Lossₘᵢₙ (−0.34 dB in FIG. 1). The difference between Lossₘₐₓ and Lossₘᵢₙ is referred to as an attenuation range (Att. Range). The desired spectrum shape may be maintained only within Δλ₁, and the spectrum shape in other wavelength ranges does not matter. In addition to the spectrum shape depicted in FIG. 1, if a spectrum in which the transmittance changes linearly with respect to wavelength, for example, within Δλ₁, is realized, the gain equalizer operates as a tilt equalizer. Similarly, in this case, the slope (dB/nm) of the spectrum shape is controlled by adjusting the amount of phase shift in each arm waveguide. In the case of a tilt equalizer, the Att. Range is expressed by [slope of spectrum shape×Δλ₁].

In a gain equalizer using a lattice-type optical circuit, in order to control the gain equalization spectrum shape with a high degree of freedom, it is desirable that a feasible Att. Range is wide. In the gain equalizer with a lattice-type optical circuit, it is Θᵢ expressed by Equation (1) that determines the gain equalization spectrum and the Att. Range. Θᵢ is determined by the difference ΔLᵢ in length between the upper arm waveguide and the lower arm waveguide in the arm waveguide, and the phase difference φᵢ (hereinafter referred to as the amount of phase modulation φᵢ) applied between the arm waveguides by controlling the phase shifter.

ΔLᵢ is fixed by the optical circuit design and determines the gain equalization spectrum in the initial state without modulation in the phase shifter. The gain equalization spectrum is changed from the initial state by adding the amount of phase modulation φᵢ to the lattice-type optical circuit in the initial state. In order to change the Att. Range over a wide range, it is necessary to significantly change the amount of phase modulation φᵢ, and the maximum value of the required amount of phase modulation also increases. In a case where a thermo-optic phase shifter is used as the phase shifter, the amount of phase modulation is controlled by a current applied to a heater, and thus as the amount of phase modulation to be applied increases, a larger amount of driving current is required. Therefore, in order to change the Att. Range over a wide range, it is necessary to apply a large driving current to each heater, which results in increasing power consumption.

In addition, in the gain equalizer with a lattice-type optical circuit, by increasing the number of stages (N-1) of the lattice-type optical circuit, it is possible to realize a more complex gain equalization spectrum with a high degree of freedom. However, as the number of stages increases, the number of phase shifters loaded on each arm waveguide also increases, and the number of phase shifters to which a driving current is applied increases, which results in further increasing power consumption. As such, the conventional gain equalizer with a lattice-type optical circuit has a problem in that the gain equalization spectrum cannot be controlled with a high degree of freedom within limited power consumption.

### CITATION LIST

### Non Patent Literature

[NPL 1] K. Suzuki, T. Kitoh, S. Suzuki, Y. Inoue, Y. Hbbino, T. Shibata, A. Mori, and M. Shimizu, “Ultra wide range dynamic gain equalizer with high contrast silica planar lightwave circuit,” in Integrated Photonics Research, A. Sawchuk, ed., Vol. 78 of OSA Trends in Optics and Photonics (Optical Society of America, 2002), paper IThG2.
[NPL 2] T. R. Schlipf, M. W. Street, J. Pandavenes, R. McBride, and D. R. S. Cumming, “Design and Analysis of a Control System for an Optical Delay-Line Circuit Used as Reconfigurable Gain Equalizer,” Journal of Lightwave Technology, Vol. 21, Issue 9, pp. 1944 (2003).

### SUMMARY OF INVENTION

An object of the present invention is to provide a gain equalizer with a lattice-type optical circuit capable of realizing a gain equalization spectrum having a high degree of freedom with less power consumption.

According to the present invention, in order to achieve such an object, there is provided an embodiment including: an optical waveguide circuit formed on a substrate and configured with an input waveguide, N (N is an integer equal to or greater than 3) 2-input and 2-output optical multiplexing/demultiplexing circuits, N-1 arm waveguides configured with two waveguides providing connections between the optical multiplexing/demultiplexing circuits, and an output waveguide, the optical waveguide circuit including a phase shifter loaded on at least one of the arm waveguides; and an optical folded part configured to output light input from the output waveguide to the output waveguide again.

### BRIEF DESCRIPTION OF DRAWINGS

FIG. 1 is a diagram illustrating an example of a gain equalization spectrum in a conventional lattice-type optical circuit.

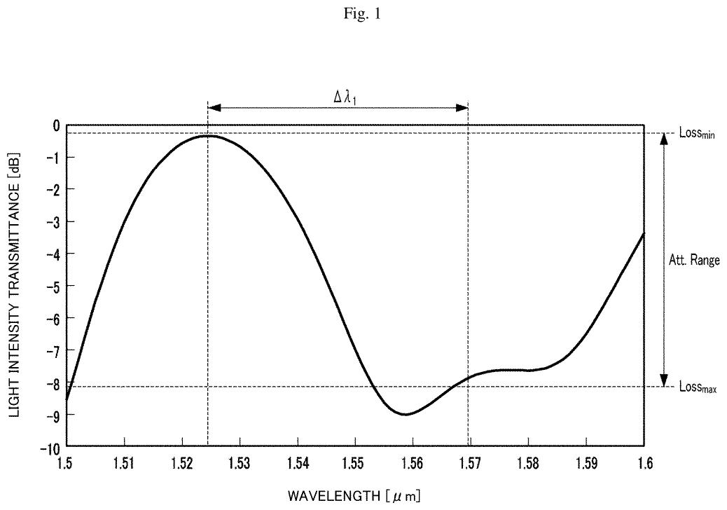

FIG. 2 is a diagram illustrating a configuration of a gain equalizer according to a first embodiment of the present invention.

FIG. 3 is a diagram illustrating a configuration of a gain equalizer according to a second embodiment of the present invention.

FIG. 4 is a diagram illustrating a configuration of a gain equalizer according to a third embodiment of the present invention.

### DESCRIPTION OF EMBODIMENTS

Hereinafter, embodiments of the present invention will be described in detail with reference to the accompanying drawings.

### First Embodiment

### (Configuration)

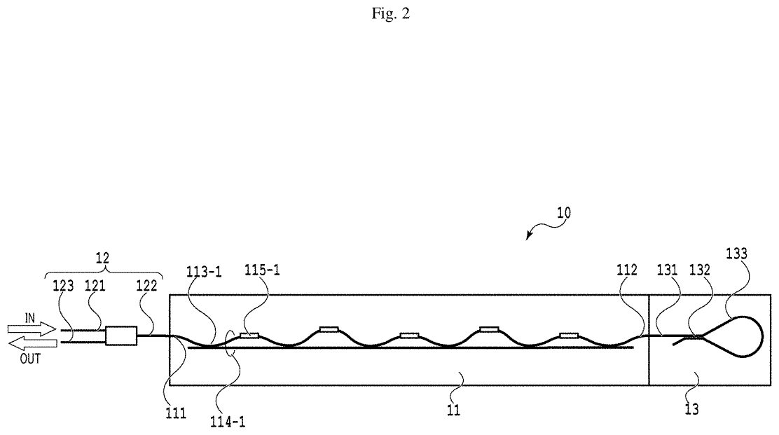

FIG. 2 illustrates a configuration of a gain equalizer according to a first embodiment of the present invention. A gain equalizer 10 is configured with a lattice-type optical circuit 11, an input/output separation mechanism 12, and an optical folded part 13. The lattice-type optical circuit 11 and the optical folded part 13 are configured with a PLC, and are depicted as a perspective view of a circuit configuration of an optical waveguide circuit formed on a substrate seen from the upper surface.

The lattice-type optical circuit 11 is configured with an input waveguide 111, a plurality of optical directional couplers 113-1 to 113-N, arm waveguides 114-1 to 114-(N-1), and an output waveguide 112 (N is an integer equal to or greater than 3). The optical directional couplers 113-1 to 113-N may be any optical circuit element insofar as they are 2-input and 2-output optical multiplexing/demultiplexing circuits. The arm waveguides 114-1 to 114-(N-1) are configured with two waveguides providing a connection between two optical directional couplers, and at least one of the waveguides is loaded with phase shifters 115-1 to 115-(N-1). An optical signal input from the input waveguide 111 passes through the optical directional couplers 113-1 to 113-N and the arm waveguides 114-1 to 114-(N-1) in order, and is output from the output waveguide 112.

The optical folded part 13 may be integrated with the lattice-type optical circuit 11, or may be configured to be externally connected through an optical fiber or the like. An optical folded part may be configured with a reflection mirror attached to the output end face of the output waveguide 112 of the lattice-type optical circuit 11. Further, a reflection mirror may be installed at the end of the optical waveguide connected to an input/output port 131 of the optical folded part 13. Insofar as light input from the input/output port 131 of the optical folded part 13 is output from the input/output port 131 again, the configuration of the optical folded part 13 does not matter.

The optical folded part 13 of the first embodiment is configured with an optical directional coupler 132 which is a 2-input and 2-output optical multiplexing/demultiplexing circuit and a loop waveguide 133 that connects two output ports of the optical directional coupler 132. The light input from the input/output port 131 is separated into 50% intensities by the optical directional coupler 132. The separated beams of light travel in reverse directions to each other in the loop waveguide 133 and interfere with each other again in the optical directional coupler 132, and light with a light intensity of 100% is output from the input/output port 131.

The input/output separation mechanism 12 may be integrated with the lattice-type optical circuit 11, or may be externally connected through an optical fiber or the like. The input/output separation mechanism 12 includes ports 121 to 123. Light input from the port 121 is output from the port 122, and light input from the port 122 is output from the port 123. Examples of the input/output separation mechanism 12 include a 3 dB coupler, a wavelength-independent coupler, and the like when integrated with the lattice-type optical circuit 11, and include an optical circulator and the like when connected externally.

### (Phase Shifter)

At least one of the arm waveguides 114-1 to 114-(N-1) is loaded with each of the phase shifters 115-1 to 115-(N-1). The phase shifters 115-1 to 115-(N-1) have a function of controlling the phase of the optical signal passing therethrough. Although the principle of the phase shifter does not matter insofar as it is available to control the phase of the optical signal passing therethrough, examples of the phase shifter include a thermo-optic phase shifter that utilizes heat generated by a heater and the thermo-optic effect. In the case of a thermo-optic phase shifter, heat to be generated is controlled by the amount of current applied to a heater, and a resultant refractive index change and amount of phase modulation are controlled. As the amount of phase modulation to be applied increases, a larger amount of driving current is required.

### (Operating Principle)

With the above configuration, the operation of the gain equalizer according to the first embodiment will be described. When an optical signal is input to the port 121 of the gain equalizer 10, the optical signal is input to the input/output separation mechanism 12 and output from the port 122. The light output from the port 122 is input to the lattice-type optical circuit 11 through the input waveguide 111.

The optical signal input to the lattice-type optical circuit 11 is output from the output waveguide 112 after undergoing gain equalization according to a gain equalization spectrum determined by the amount of phase modulation in the phase shifters 115-1 to 115-(N-1). The light output from the output waveguide 112 is converted to be propagated in the reverse direction by the optical folded part 13, and is input to the lattice-type optical circuit 11 again through the output waveguide 112.

The optical signal propagates within the lattice-type optical circuit 11 in a reverse direction to a direction in which it passes through the lattice-type optical circuit for the first time, and is output from the input waveguide 111. The light output from the lattice-type optical circuit 11 is input to the input/output separation mechanism 12 through the port 122 and output from the port 123.

In the gain equalizer 10 of the first embodiment, the input optical signal passes through the lattice-type optical circuit 11 twice in the forward direction and in the backward direction. That is, a reciprocating propagation is performed. According to the principle of backward propagation of light, transmission spectra become the same as each other between: a case where the optical signal is input to the lattice-type optical circuit 11 from the input waveguide 111 and output from the output waveguide 112; and a case where the optical signal is input to the lattice-type optical circuit 11 from the output waveguide 112 and output from the input waveguide 111. Therefore, in a case where the reciprocating propagation is performed in the lattice-type optical circuit 11 of the first embodiment, it is possible to obtain the same gain equalization effect as when passing through one lattice-type optical circuit twice.

### (Reduction of Power Consumption Due to Reciprocating Propagation)

In the gain equalizer 10 of the first embodiment, since the reciprocating propagation is performed in the lattice-type optical circuit 11, in a case where the amount of phase modulation in each of the phase shifters 115-1 to 115-(N-1) is fixed, the Att. Range of the obtained gain equalization spectrum becomes twice as compared with the case of the conventional one-way propagation. In other words, when there is a desired gain equalization spectrum, the gain equalizer 10 of the first embodiment merely requires a half of the Att. Range of the lattice-type optical circuit as compared with a gain equalizer based on the conventional one-way propagation. For example, in a case where the gain equalizer 10 of the first embodiment is desired to be operated in the Att. Range of 0 to 8 dB, the lattice-type optical circuit 11 alone is enough to be able to realize the Att. Range of 0 to 4 dB. In this way, since the Att. Range required by the lattice-type optical circuit 11 can be narrowed, the range of the required amount of phase modulation can also be narrowed, and thus the amount of driving current for the phase shifter can be reduced. That is, power consumption can be reduced.

As an example, a case where a tilt equalizer is configured with a lattice-type optical circuit of N=6 can be considered. In this tilt equalizer, the optical circuit is designed so that a gain equalization spectrum in the initial state (during non-modulation) has a waveform with a slope of 0. When a gain equalization spectrum with a spectrum waveform slope of 0.2 dB/nm (corresponding to Att. Range=8 dB in the C band of the optical communication wavelength band) is desired to be output, according to the gain equalizer 10, the lattice-type optical circuit 11 alone is enough to operate as a gain equalizer with a spectrum waveform slope of 0.1 dB/nm (corresponding to Att. Range=4 dB in the C band). In this case, the required power consumption can be reduced by approximately 25% as compared with a gain equalizer that merely brings a conventional lattice-type optical circuit into one-way propagation.

### Second Embodiment

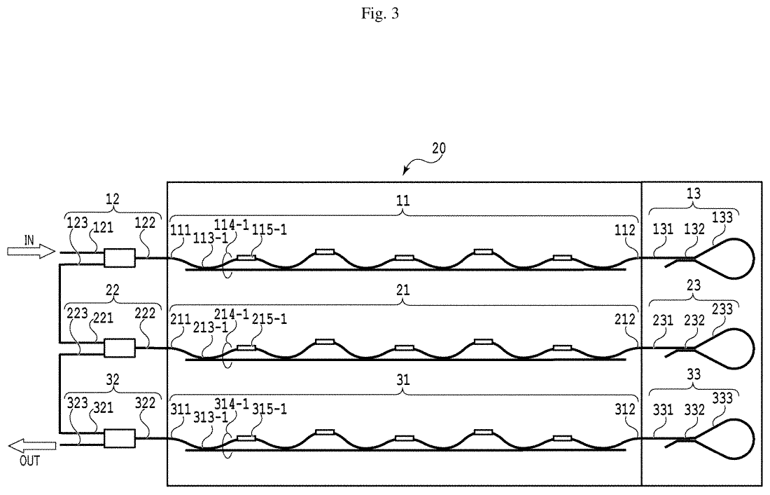

FIG. 3 illustrates a configuration of a gain equalizer according to a second embodiment of the present invention. The gain equalizer 10 of the first embodiment includes one each of the lattice-type optical circuit 11, the input/output separation mechanism 12, and the optical folded part 13. The number of lattice-type optical circuits is not limited to this, and a plurality of lattice-type optical circuits may be included.

As depicted in FIG. 3, a gain equalizer 20 has a plurality of lattice-type optical circuits 11, 21, and 31 connected in cascade to each other. An output port 123 of a first input/output separation mechanism 12 is connected to an input port 221 of a second input/output separation mechanism 22. After a reciprocating propagation is performed in a first lattice-type optical circuit 11, a reciprocating propagation can be performed in a second lattice-type optical circuit 21. Further, an output port 223 of the second input/output separation mechanism 22 is connected to an input port 321 of a third input/output separation mechanism 32. After a reciprocating propagation is performed in the second lattice-type optical circuit 21, a reciprocating propagation can be performed in a third lattice-type optical circuit 31. In a case where the gain equalizer 20 is configured with the three lattice-type optical circuits 11, 21, and 31, the gain equalization spectrum of the entire gain equalizer can achieve a larger Att. Range than in a case where the number of lattice-type optical circuits is single.

### Third Embodiment

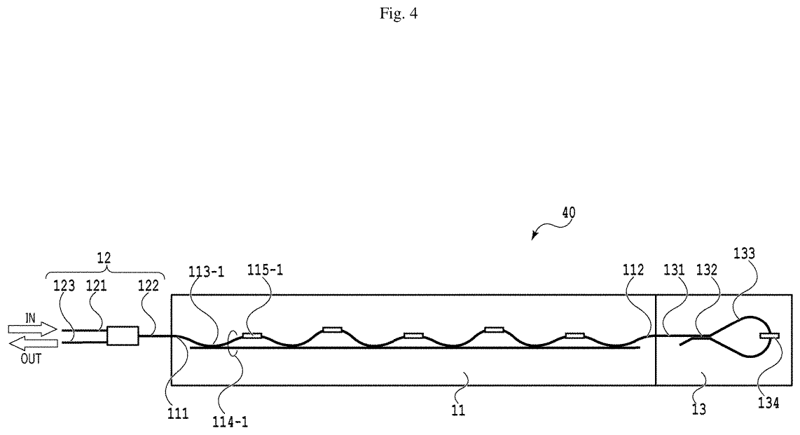

FIG. 4 illustrates a configuration of a gain equalizer according to a third embodiment of the present invention. A gain equalizer 40 is configured with the lattice-type optical circuit 11, the input/output separation mechanism 12, and the optical folded part 13. The lattice-type optical circuit 11 and the optical folded part 13 are configured by a PLC, and are depicted as a perspective view of a circuit configuration of an optical waveguide circuit formed on a substrate seen from the upper surface. The difference from the first embodiment is that a polarization rotation mechanism 134 is provided at the center of the loop waveguide 133 of the optical folded part 13.

The polarization rotation mechanism 134 is an element that rotates the polarization direction of light propagating through the loop waveguide 133 by 90°. As the polarization rotation mechanism 134, for example, a wavelength plate is used, and a ½ wavelength plate for shifting the phase difference between the main axis and the slow axis by π is particularly effective. With placing the ½ wavelength plate so that its main axis is inclined at 45° with respect to the substrate surface of the loop waveguide 133, the polarization direction of the light propagating through the loop waveguide 133 is rotated by 90°. In this way, the TE mode and the TM mode of the optical waveguide can be mutually converted in the optical folded part 13.

In the gain equalizer 40 of the third embodiment, when the reciprocating propagation is performed in the lattice-type optical circuit 11, the light with the TE mode on the forward path is subjected to a polarization rotation in the optical folded part 13, and is transmitted through the lattice-type optical circuit with the TM mode on the backward path. Therefore, the polarization dependent characteristics are cancelled by the reciprocating propagation in the lattice-type optical circuit 11, and a gain equalizer with a small polarization dependent loss (PDL) can be achieved as a whole.

As described above, according to the present embodiment, a gain equalization spectrum with a high degree of freedom can be achieved with less power consumption in a gain equalizer using a lattice-type optical circuit.

1. Again equalizer comprising:
an optical waveguide circuit formed on a substrate and configured with an input waveguide, N (N is an integer equal to or greater than 3) 2-input and 2-output optical multiplexing/demultiplexing circuits, N-1 arm waveguides configured with two waveguides providing connections between the optical multiplexing/demultiplexing circuits, and an output waveguide, the optical waveguide circuit including a phase shifter loaded on at least one of the arm waveguides; and
an optical folded part configured to output light input from the output waveguide to the output waveguide again.

2. The gain equalizer according to claim 1, wherein the optical folded part is a reflection mirror provided at an output end face of the output waveguide.

3. The gain equalizer according to claim 1, wherein the optical folded part includes an optical waveguide connected to the output waveguide and a reflection mirror installed at an end of the optical waveguide.

4. The gain equalizer according to claim 1, wherein the optical folded part includes a second 2-input and 2-output optical multiplexing/demultiplexing circuit connected to the output waveguide and a loop waveguide connecting two output ports of the second optical multiplexing/demultiplexing circuit.

5. The gain equalizer according to claim 1, further comprising an input/output separation mechanism connected to the input waveguide and configured with an optical circulator.

6. The gain equalizer according to claim 1, wherein the optical waveguide circuit is made of a quartz-based material formed on a silicon substrate.

7. The gain equalizer according to claim 1, wherein the phase shifter utilizes a thermo-optic effect.
